(19) United States
(12) Patent Application Publication
(10) Pub. No.: US 2012/0103944 A1
(43) Pub. Date: May 3, 2012

(54) Manufacturing Method of Fuel Filler Tube

(75) Inventors: Kazushige Nishida, Soja-shi (JP); Kuyama Masahiro, Soja-shi (JP)

(73) Assignee: Asteer Co., Ltd., Soja-shi (JP)

(21) Appl. No.: 13/283,332

(22) Filed: Oct. 27, 2011

(30) Foreign Application Priority Data
Oct. 29, 2010 (JP) 2010-243414

(51) Int. Cl. B23K 11/06

(52) U.S. Cl. 219/78.01

(57) ABSTRACT

An annular surface of a retainer made of stainless steel plate and an annular surface of an inlet pipe made of zinc plated steel plate are surface contacted. Seam welding is then applied within a surface contacting region of the retainer and the inlet pipe to form a gap at both ends of the surface contacting region, and a zinc plated layer of the inlet pipe is melted to extrude zinc to the gap thus filling the gap with the zinc. According to such manufacturing method, a fuel filler tube excelling in rust preventing performance can be provided without performing a separate rust preventing countermeasure.

### BACKGROUND OF THE INVENTION

1. Field of the Invention

The present invention relates to a manufacturing method of a fuel filler tube including a retainer made of a stainless steel plate, and an inlet pipe made of a zinc plated steel plate.

2. Description of the Related Art

A fuel filler tube is configured by a retainer for attaching a cap, and an inlet pipe extending from the retainer to a fuel tank. Since the retainer and the inlet pipe are usually made of metal members, high rust preventing performance is demanded on both members. If the retainer and the inlet pipe are integrally configured, by using a stainless steel plate for the retainer and the inlet piper, high rust preventing performance is obtained according to a passive coated layer of the stainless steel plate. However, the cost increases if the retainer and the inlet piper are made of the stainless steel plate. In order to reduce the cost, an inexpensive steel plate or a plated steel plate is used. A rust preventing coating is applied to them as necessary.

For instance, the fuel filler tube disclosed in Japanese Laid-Open Patent Publication No. 2010-012893 (referred to as JP 2010-012893 hereafter) uses a tin-zinc plated steel plate for the inlet pipe and a stainless steel plate for the retainer to reduce cost (claims 2 and 3). According to the descriptions in claims 1 and 3, paragraphs [0019] and [0020], a cation electrodeposition coating is carried out by dipping the fuel filler tube in paint liquid to form a coated film made of urethane paint or the like over the entire fuel filler tube. According to the descriptions in paragraphs [0009] and [0010], they mean that the inlet pipe made of the tin-zinc plated steel plate is not only easy to manufacture and can reduce cost, but can also enhance the rust preventing performance, and the rust preventing performance can be maintained by the cation electrodeposition coating. Furthermore, according to the descriptions in paragraphs [0010] and [0028], they mean that the plated layer will not strip when processing the retainer since the stainless steel plate is not plated, and hence the lowering in the rust preventing performance can be suppressed. According to the description in paragraph [0012], the retainer and the inlet pipe are joined by welding or brazing.

When the stainless steel plate is welded or brazed to another member, the passive coated layer is destroyed by the heat (this is called as a welding burn) generated in welding or brazing and cannot be reproduced, thus causing a corrosion called a grain boundary corrosion. In the case of the stainless steel plate which is not undergone the welding burn, even if the passive coated layer on the surface is destroyed, the passive coated layer is immediately reproduced. However, if the welding is involved, the surface of the stainless steel plate is exposed to high temperature (500° C. to 850° C.). Chromium and carbon then bond together for depositing chromium carbon at the surface layer of the stainless steel plate, whereby the passive coated layer is broken and the grain boundary corrosion occurs therefrom. The stainless steel passive coated layer is formed when the chromium contained in the stainless steel oxidizes, but the chromium carbon is generated immediately below the surface layer and the content of the chromium relatively lowers when the stainless steel plate is subjected to the welding process, whereby the reproduction of the passive coated layer is inhibited and the rust preventing performance of the stainless steel plate is significantly lowered.

The fuel filler tube of JP 2010-012893 is entirely subjected to the cation electrodeposition coating. Therefore, the occurrence of the grain boundary corrosion may be suppressed by the coated film even if the retainer made of stainless steel and the inlet pipe made of tin-zinc plated steel plate are joined by welding. However, the method of JP 2010-012893 performing the cation electrodeposition coating has large number of steps, which becomes the cause of increase in cost.

A fuel filler tube configured by joining a retainer made of stainless steel plate and an inlet pipe made of stainless steel plate through seam welding is disclosed in Japanese Laid-Open Patent Publication No. 2004-210003. The gap formed between the inlet pipe and the retainer by the seam welding is blocked with a paint by powder coating. The rust preventing performance of the fuel filler tube is adequate, but the number of steps is still large thus becoming the cause of increase in cost.

An object of the present invention is to provide a manufacturing method of a fuel filler tube using the stainless steel plate for the retainer and the inexpensive plated steel plate for the inlet pipe, wherein the manufacturing cost is reduced by eliminating rust preventing countermeasures separately performed such as the cation electrodeposition coating or the powder coating, which is essential in the prior art, and high rust preventing performance is exhibited.

### SUMMARY OF THE INVENTION

The above object is achieved by a manufacturing method of a fuel filler tube, the method including the steps of surface contacting an annular surface for connection of a retainer made of a stainless steel plate and an annular surface for connection of an inlet pipe made of a zinc plated steel plate to join the retainer and the inlet pipe; and applying a seam welding within a surface contacting region of the retainer and the inlet pipe by pushing a pair of roller electrodes against a back side of the annular surface of the inlet pipe and a back side of the annular surface of the retainer and rotating the pair of electrodes to form a gap at both ends of the surface contacting region, and melting a zinc plated layer of the inlet pipe to extrude zinc from the zinc plated layer to the gap and filling the gap with the zinc, wherein a film thickness of the zinc plated layer of the inlet pipe is greater than or equal to 11 μm and smaller than or equal to 25 μm.

As the passive coated layer is broken by the welding heat in the vicinity of the surface contacting region, rust easily occurs if an environment where rust easily occurs such as when the fuel filler tube is remained wet is realized. In the present invention, the zinc is extruded and collected in the gap on both sides of the surface contacting region, so that the portion where the passive coated layer is broken in the stainless steel plate is covered with zinc oxide that eluted and deposited from the collected zinc. Here, the zinc oxidizes and white rust easily generates if zinc and water are in contact for a long period of time. In the present invention, the stainless steel plate is prevented from rusting with such white rust. Since the gap where the zinc is collected is in the vicinity of a region where the passive coated layer is broken, the zinc oxide easily diffuses to a region where the passive film is broken due to moisture and the like, which becomes the cause of rust. In JP 2010-012893, occurrence of rust in the plated layer itself is prevented by an alloy plated layer of tin (normal electrode potential: 0.146V) and zinc (normal electrode potential: 0.762V), and hence protection of the broken passive film of the stainless steel plate by the zinc oxide cannot be expected. In the present invention, zinc is oxidized before the steel plate, which is the base of the plated layer, is oxidized. The zinc is eluted by the sacrificial anticorrosion effect of the zinc and deposit zinc oxide. The stainless steel plate is prevented from rusting by a resultant zinc oxide.

Since it takes some time for the zinc oxide to diffuse and cover the surface of the stainless steel plate, it is concerned that the grain boundary corrosion may occur in the stainless steel plate. However, the zinc oxide can cover the surface of the stainless steel plate before the red rust caused by the grain boundary corrosion of the stainless steel plate occurs since oxidation of the zinc is much faster than oxidation of the stainless steel plate.

Members to be joined are applied with current and heated by an electrical resistance thereof in the seam welding. Therefore, the members to be joined are heated in the range where the electrode is pressed and vicinity thereof. Since the inlet pipe is made of zinc plated steel plate, the zinc plated layer temporarily melts. Here, the roller electrodes are pushed against the back side of the annular surface of the retainer and the back side of the annular surface of the inlet pipe. Therefore, both sides of the surface contacting region in the annular surface of the retainer and the annular surface of the inlet pipe relatively bends and forms a slight gap. The zinc in the molten plated layer is extruded to the gap by being pressed with the roller electrodes.

As described above, the zinc oxide that covers the surface of the stainless steel plate is generated from the zinc extruded to the gap formed on both sides of the surface contacting region. Therefore, the zinc oxide can diffuse to a wider range as the amount of the zinc extruded to the gap is larger, and the surface of the stainless steel plate can be more easily covered with zinc. Since the range heated by the seam welding is normally limited to the range where the electrode is pressed and the vicinity thereof, zinc oxide merely needs to diffuse to the range where the electrode is pressed and the vicinity thereof. The extruded amount of zinc is correlated with the thickness of the zinc plated layer of the inlet pipe. As will be described later, it was found as a result of the salt spray test compliant with JIS Z 2371 that the thickness of the zinc plated layer of the inlet pipe needs to be greater than or equal to 11 μm and smaller than or equal to 25 μm.

The electroplating method is advantageous in that a film having designed thickness is easily formed, and that the attachment of the rust preventing paint is satisfactory. However, the film thickness that can be formed is about a few μm at the most. Although it may be sufficient to form the tin-zinc plated layer of JP 2010-012893, it is difficult to form the zinc plated layer suitable for the present invention. Therefore, the hot-dip plating method is preferably used to form the plated layer having a thickness of greater than or equal to 11 μm. The rust preventing performance of the entire inlet pipe also is enhanced since the thickness of the plated layer given to the entire inlet pipe is also greater than or equal to 11 μm. The thickness of the plated layer is ideally thicker. However, the thickness of the plated layer given to the zinc plated steel plate is smaller than or equal to 25 μm since the upper limit by the hot-dip plating method is normally 25 μm.

Since the zinc of the zinc plated layer can be diffused to prevent rust without performing a special countermeasure for preventing the rust, the labor and the cost required for rust preventing countermeasure is reduced, according to the manufacturing method of the present invention. The cost can also be reduced in terms of material since the zinc plated steel plate configuring the inlet pipe is cheaper than the tin-zinc plated steel plate.

The retainer is configured from the stainless steel plate, and the inlet pipe is configured from the zinc plated steel plate. It is concerned that the galvanic corrosion may occur in the gap of the surface contacting region of the annular surface of the retainer and the annular surface of the inlet pipe since the retainer and the inlet pipe are configured by different types of metals. However, in the fuel filler tube manufactured by the present invention, the occurrence of galvanic corrosion can be prevented with the zinc oxide generated from the zinc extruded from the surface contacting region.

### BRIEF DESCRIPTION OF THE DRAWINGS

FIG. 1 is a cross-sectional view of one part of a fuel filler tube manufactured by the present invention;

FIG. 2 is a cross-sectional view corresponding to FIG. 1 illustrating a state in which a retainer is detached from an inlet pipe;

FIG. 3 is a cross-sectional view corresponding to FIG. 1 illustrating the fuel filler tube during seam welding;

FIG. 4 is an enlarged cross-sectional view of the portion of the arrow A in FIG. 3; and

FIG. 5 is an enlarged cross-sectional view corresponding to FIG. 4 illustrating a state in which an oxide layer of zinc is formed.

### DETAILED DESCRIPTION OF THE PREFERRED EMBODIMENTS

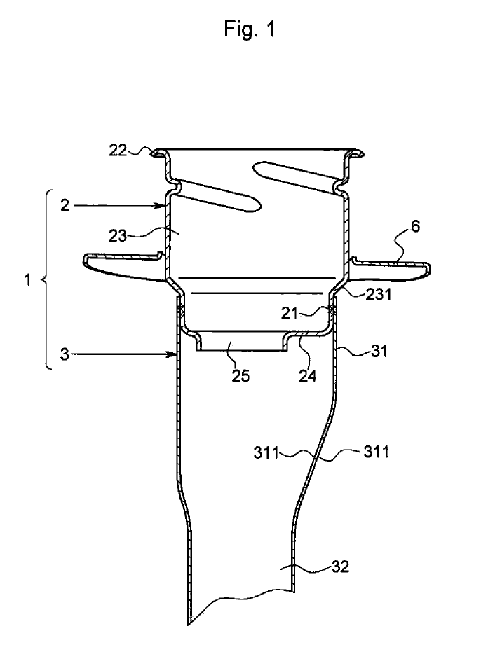

The manufacturing method of the present invention will be described with reference to the drawings of a fuel filler tube to be manufactured. The fuel filler tube illustrated in the drawings is an example and other shape may be adapted. The present invention relates to a manufacturing method of a fuel filer tube 1 including a retainer 2 made of stainless steel plate and an inlet pipe 3 made of zinc plated steel plate, as illustrated in FIG. 1. In the conventional manufacturing method of the fuel filler tube, the same type of metal is used for the retainer 2 and the inlet pipe 3 as in JP 2004-21003 or different types of metal are used as in JP 2010-012893. When using different types of metal, the countermeasure for preventing rust is applied on the entire fuel filler tube after assembling the retainer 2 and the inlet pipe 3. In JP 2010-012893, urethane paint is applied as described above. In the manufacturing method of the fuel filler tube 1 of the present invention, the retainer 2 made of stainless steel plate and the inlet pipe 3 made of zinc plated steel plate are simply assembled, and the manufacturing method does not include any post-processing for the countermeasure for rust.

The retainer 2 is a substantially cylindrical member made of stainless steel plate. The retainer 2 of FIG. 1 is an integrally formed member, and includes an opening 22, a peripheral wall 23 formed with a female screw, an annular surface 21, a bottom end face 24, and a gun guide 25 in order from the top. The retainer 2 configures one part of the fuel filler tube 1, and supports the fuel filler tube 1 at a vehicle body 6. The opening 22 is arranged at the upper end of the retainer 2. The opening 22 has the edge having a circular cross-section folded back radially outward so that the cut end faces downward. Hand of a person is prevented from hurting by this configuration. The peripheral wall 23 is a cylindrical portion continuing from the opening 22 to the lower side. The peripheral wall 23 includes a screw protrusion projecting radially inward serving as the female screw. The male screw of the filler cap is screw fitted to the female screw to tighten and attach the filler cap (not shown) to the retainer 2. Various methods can be adapted to shape the retainer 2. The retainer 2 of FIGS. 1 to 5 is formed by a deep drawing using a pressing machine.

The annular surface 21 of the retainer 2 is a joining site that surface contacts with an annular surface 31 of the inlet pipe 3. In the embodiment of FIGS. 1 to 5, the annular peripheral wall at the lower end of the retainer is the annular surface 21. Although not shown, one part of the stainless steel plate configuring the retainer is processed so as to bulge out outward in the normal direction from the wall surface of the retainer thus forming an annular flange, and such flange may be assumed as the annular surface 21.

The annular surface 31 of the inlet pipe 3 is a joining site that surface contacts with the annular surface 21 of the retainer 2. In the example of FIGS. 1 to 5, the annular peripheral wall extending to the upper end of the inlet pipe 3 is the annular surface 31. Although not shown, one part of the zinc plated steel plate configuring the inlet pipe 3 is processed so as to bulge out outward in the normal direction from the wall surface of the inlet pipe 3 thus forming an annular flange, and such flange may be assumed as the annular surface 31.

If the annular surface 21 of the retainer 2 and the annular surface 31 of the inlet pipe 3 are the flanges, the flange of the retainer 2 and the flange 3 of the inlet pipe are first surface contacted. The surface contacted flanges are then sandwiched with a pair of roller electrodes from above and below to join the flanges by seam welding around the entire periphery. In this case, the roller electrodes are to come in contact with the back side of the flanges so as to fall within the surface contacting region of the flanges. The pair of roller electrodes are both on the outer side of the retainer 2 and the inlet pipe 3.

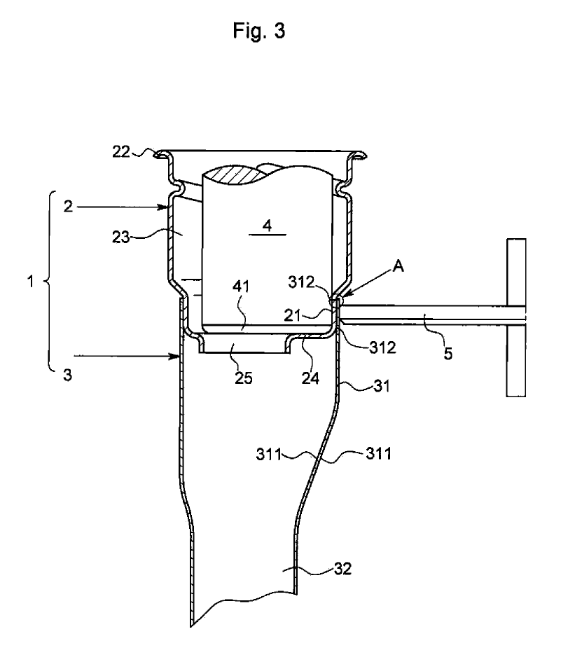

If the annular surfaces 21, 31 of the retainer 2 and the inlet pipe 3 are assumed as the annular peripheral wall as in the embodiment illustrated in FIGS. 1 to 5, the inlet pipe 3 is first fitted to the retainer 2 to surface contact the annular surfaces 21, 31, as illustrated in FIG. 3. The surface contacted peripheral walls (annular surfaces 21, 31) are then sandwiched with a pair of roller electrodes 4, 5 from the inside and the outside of the retainer 2 to join the annular peripheral walls by seam welding around the entire periphery. In this case, one of the roller electrodes 4, 5 is on the inner side of the retainer 2 and the inlet pipe 3 and the other one is on the outer side.

The air tightness and the water tightness at the joined site of the retainer 2 and the inlet pipe 3 are ensured by the seam welding. The leakage of fuel vapor or fuel is thereby prevented, and penetration of rainwater and the like is prevented. The width of the annular surface 21 of the retainer 2, that is, the height of the annular peripheral wall is greater than the roller electrode 5 that contacts with the outer side of the retainer 2. Here, the height of the annular surface 21 is set such that the gun guide 25 does not become too deep.

The bottom of the annular surface 21 of the retainer 2 is formed to a circular flat surface, which becomes the bottom end face 24. The bottom end face 24 is orthogonal to the annular surface 21 of the retainer, thus enhancing the rigidity of the retainer 2 and enhancing the shape retention property. The gun guide 25 is formed in the bottom end face 24. The gun guide 25 has an inner diameter slightly greater than the outer shape of a filler gun so as to guide the filler gun inserted from the opening 22 to the inlet pipe 3. The filler gun can be easily inserted if the gun guide 25 is formed at a position off-centered to the peripheral edge of the bottom end face 24. The gun guide 25 enhances the rigidity of the bottom end face 24.

The retainer 2 is attached to the upper end of the inlet pipe 3. The lower end of the inlet pipe 3 is connected to a fuel tank. The inlet pipe 3 is shaped from a zinc plated steel plate. Various methods can be adapted to shape the inlet pipe 3. In the embodiment of FIGS. 1 to 5, the inner diameter of the upper end of a straight pipe is enlarged to be the inlet pipe 3 by inserting a punch until the inner diameter corresponds to the outer shape of the annular surface 21 of the retainer 2, thus forming the annular surface 31 for receiving the annular surface 21 of the retainer 2. The diameter of a tube main body 32 on the lower side of the inlet pipe 3 is not particularly enlarged. The bottom end face 24 and the gun guide 25 of the retainer 2 can be seen when viewed from the inlet pipe 3 side with the retainer 2 fitted to the inlet pipe 3.

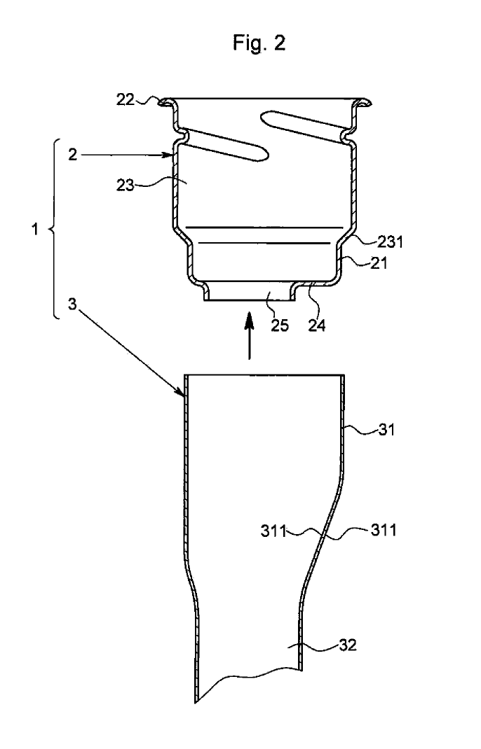

As illustrated in FIG. 2, a tapered annular surface 231 is preferably formed between the peripheral wall 23 and the annular surface 21 of the retainer 2. Since the upper end edge of the inlet pipe 3 contacts with the boundary portion of the annular surface 21 and the tapered annular surface 231, the retainer 2 is properly positioned when fitting the retainer 2 to the inlet pipe 3.

As illustrated in FIG. 3, the seam welding is preferably carried out by placing the side surface of the circular column shaped roller electrode 4 against the inner circumferential surface of the annular surface 21 of the retainer 2, pushing the circumferential surface of the circular disc shaped roller electrode 5 against the outer circumferential surface of the annular surface 31 of the inlet pipe 3, and rolling the rollers to weld around the entire periphery. In this case, the width of the roller electrode 5 is to fall within the surface contacting region of the outer circumferential surface of the annular surface 21 of the retainer 2 and the inner circumferential surface of the annular surface 31 of the inlet pipe 3. The circular column shaped roller electrode 4 is preferably configured with the distal end as an insulating surface 41, and the welding is preferably carried out while pushing the insulating surface 41 against the bottom end face 24 of the retainer 2 at the time of welding. Since the circular column shaped roller electrode 4 and the circular disc shaped roller electrode 5 are pushed against the retainer 2 and the inlet pipe 3 while rotating, the roller electrode 4 is stabilized if the insulating surface 41 of the circular column shaped electrode 4 is pushed against the bottom end face 24 of the retainer 2.

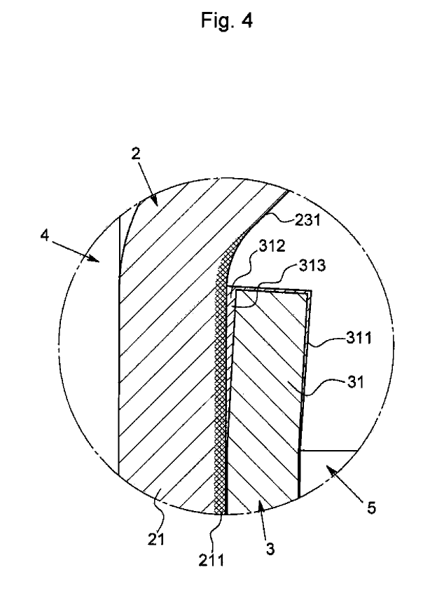

The seam welding is a welding method of temporarily melting and joining the joining materials, and hence a plated layer 311 of the inlet pipe 3 made of zinc plated steel plate is temporarily melted by resistance heating. In this case, the annular surface 31 of the inlet pipe 3 slightly warps and a gap 312 forms at both ends of the surface contacting region since the roller electrode 5 is pushed against the outer circumferential surface of the annular surface 31 of the inlet pipe 3 within the surface contacting region of the outer circumferential surface of the annular surface 21 of the retainer 2 and the inner circumferential surface of the annular surface 31 of the inlet pipe 3. As illustrated in FIG. 4, zinc is extruded from the surface contacting region of the annular surface 21 of the retainer 2 and the annular surface 31 of the inlet pipe 3 to the gap 312 by being pressed by the roller electrodes 4, 5 and extruded zinc fills the gap 312.

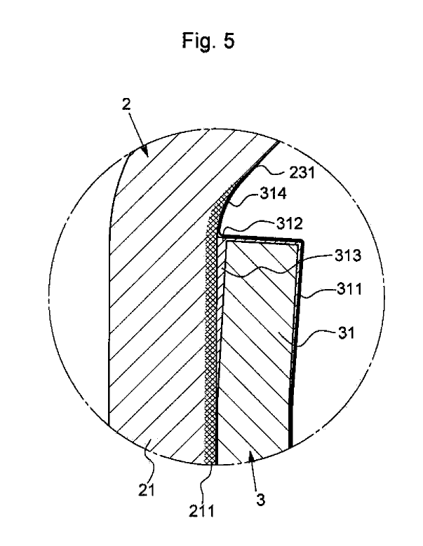

Although the retainer 2 includes the passive coated layer made of stainless steel plate, the passive coated layer is broken by the seam welding as illustrated in FIG. 4. In FIG. 4, Cross-hatching pattern is placed on a breakage region 211 where the passive coated layer is broken. The breakage region 211 of the passive coated layer extends to the tapered annular surface 231 and the bottom end face 24 with the annular surface 21 of the retainer 2 as the center. The outer peripheral edge of the breakage region 211 of the passive coated layer is positioned in the vicinity of zinc 313 collected in the gap 312. When a state in which rust easily occurs is realized Such as when the joining region of the retainer 2 and the inlet pipe 3 gets wet, the breakage region 211 of the passive coated layer is covered with an deposited oxide layer 314 which are eluted from the zinc 313 and deposited, as illustrated in FIG. 5. Thus, occurrence of rust of the retainer 2 is prevented with deposited zinc oxide in place of the passive coated layer. The outer circumferential surface of the annular surface 31 of the inlet pipe 3, to which the circular disc shaped electrode 5 is pushed against, becomes thin as the zinc plated layer 311 is extruded. However, the occurrence of rust of the inlet pipe 3 is suppressed since the oxide layer 314 is generated from the remaining zinc plated layer 311.

The portion sandwiched by the gap 312 at both ends of the surface contacting region is less likely to cause rust since such portion is blocked from outside. Furthermore, zinc oxide is generated from the remaining zinc plated layer 311. As illustrated in. FIG. 4, impurities are not deposited in the gap 312 since the gap 312 is filled with zinc 313. Therefore, there is no possibility that the galvanic corrosion caused by the impurities will occur. Although not shown, the gap 312 formed near the boundary of the annular surface 21 and the bottom end face 24 of the retainer is similarly filled with zinc. Therefore, the breakage region 211 of the passive coated layer near the gap 312 is also covered with the oxide layer of zinc oxide. There is no possibility that the galvanic corrosion will occur since the gap 312 is blocked with zinc.

### Example

The effectiveness of the rust preventing effect according to the present invention will be more specifically described with reference to examples and comparative examples.

The salt spray test compliant with JIS Z 2371 was conducted on a test piece (comparative example 1) in which the stainless steel plates were seam welded and test pieces (comparative examples 2 and 3, example 1) in which the stainless steel plate and the zinc plated steel plate were seem welded to verify the relationship between the thickness of the plated layer and the presence of rust occurrence. When carrying out the seam welding, the width of the roller electrodes was made smaller than the surface contacting region of the steel plate. The roller electrodes were pressed to the surface contacting region at 0.18 MPa, where the welding current was 7,500 A, the welding speed was 15 cm/s, and the plate thickness of the test piece was 1.2 mm. The SUS 436 used for the general automobile parts was used for the stainless steel plate. As the zinc plated steel plate, a carbon steel (STKM1lA), which were used for the general automobile parts, having a zinc plated layer was used. The zinc plated layer was formed by an electroplating method or a hot-dip plating method.

The comparative example 1 was the test piece in which the stainless steel plates were seam welded. The comparative example 2 was the test piece in which the steel plate formed with the zinc plated layer having a thickness of 4.2 μm and the stainless steel plate were joined through seam welding. The plated layer was formed through the electroplating method. The comparative example 3 was the test piece in which the steel plate formed with the zinc plated layer having a thickness of 6.5 μm and the stainless steel plate are joined through seam welding, similar to the comparative example 2. The plated layer was formed through the electroplating method. The example 1 was the test piece in which the steel plate formed with a zinc plated layer having a thickness of 11 μm and the stainless steel plate are joined through seam welding. The plated layer was formed through the hot-dip plating method. Although designed thickness of the plating was 12 μm, actual measurement value was 11 μm in Example 1.

The conducted salt spray test was a neutral salt spray test complying with JIS Z 2371. Specifically, the sodium chloride aqueous solution having a concentration of 50 g/L was adjusted to become pH6.5 with sodium hydroxide or hydrochloric acid. The sodium chloride aqueous solution was continuously sprayed over 300 hours in a bath (environmental temperature: 35° C.) in which each test piece of comparative examples 1 to 3 and example 1 were lined. Each test piece was laid still, and the time until rust occurred in each test piece of the comparative examples 1 to 3 and the example 1 was measured. JIS Z 2371 required that rust do not occur for 100 hours after spraying salt water. The results are summarized in table 1. “Observed” is written if red rust was found, and “Not observed” is written if red rust was not found.

TABLE 1
TABLE 1

| | | Elapsed time after salt water spray | | | |
|---|---|---|---|---|---|
| | Thickness of plating | 25 hours | 100 hours | 200 hours | 300 hours |
| Comparative 1 | None | Observed | Observed | Observed | Observed |
| Comparative 2 | 4.2 μm | Observed | Observed | Observed | Observed |
| Comparative 3 | 6.5 μm | Not observed | Observed | Observed | Observed |
| Example 1 | 11 μm | Not observed | Not observed | Not observed | Not observed |

As apparent from the test results in table 1, the rust occurred before elapse of one day (25 hours) after spraying salt water in each test piece of the comparative example 1 and the comparative example 2. It was confirmed from the result of the comparative example 1 that the rust occurred in a very short time if the stainless steel plates, which had strong rust preventing effect, were seam welded. This is assumed to be because the passive coated layer is broken by the seam welding. Furthermore, it was found from the result of the comparative example 2 that rust also occurred if the plated layer of the zinc plated steel plate was smaller than or equal to 4.2 μm when the stainless steel plate and the zinc plated steel plate were seam welded. It is concluded that the rust preventing countermeasure such as an application of rust preventing paint and others is separately required after the seam welding in the configurations of the comparative example 1 and the comparative example 2.

It was found from the result of the comparative example 3 that the occurrence of rust was suppressed for about one day after spraying the salt water if the thickness of the plated layer of the zinc plated steel plate was 6.5 μm when the stainless steel plate and the zinc plated steel plate were seam welded. However, occurrence of rust was found after elapse of four days (100 hours) after spraying the salt water. Therefore, it was found that rust occurs if the plated layer of the zinc plated steel plate was smaller than or equal to 6.5 μm when the stainless steel plate and the zinc plated steel plate were seam welded. It was found that the requirements of JIS Z 2371 were not satisfied in the comparative example 2 and the comparative example 3.

In the test piece of example 1, on the other hand, it was found that rust did not occur even after elapse of about 13 days (300 hours) after spraying the salt water. Furthermore, a white oxide layer (zinc oxide) was formed at the seam welded site when the test piece of example 1 was visually checked. Therefore, it was found that the seam welded site, that is, the region where the passive coated layer was broken was covered with the zinc oxide layer, thus preventing the occurrence of rust of the entire test piece if the plated layer of the zinc plated steel plate was greater than or equal to 11 μm when the stainless steel plate and the zinc plated steel plate were seam welded.

The test piece of example 1 in which satisfactory results were obtained in the salt spray test and the test pieces of the comparative example 2 and the comparative example 3 in which rust occurred within about four days after spraying salt water differ in the method of forming the zinc plated layer. In other words, the plated layer was formed through the hot-dip plating method in the test piece of the example 1, whereas the plated layer was formed through the electroplating method in the test pieces of the comparative example 2 and the comparative example 3. Although the electroplating method can easily form the plated layer having the designed value, the upper limit of the film thickness that can be formed is about 10 μm. On the other hand, according to the hot-dip plating method, it is difficult to form the plated layer having the intended thickness (see example 1) However, the plated layer having a thickness of greater than or equal to 10 μm can be formed according to the hot-dip method, in which upper limit of the thickness is normally about 25 μm. Therefore, it is conclude that the zinc plated layer is preferably formed through the hot-dip plating method, and the zinc plated steel plate and the stainless steel plate are preferably seam welded in the present invention.

What is claimed is:

1. A manufacturing method of a fuel filler tube, the method comprising the steps of:
surface contacting an annular surface for connection of a retainer made of a stainless steel plate and an annular surface for connection of an inlet pipe made of a zinc plated steel plate to join the retainer and the inlet pipe; and
applying a seam welding within a surface contacting region of the retainer and the inlet pipe by pushing a pair of roller electrodes against a back side of the annular surface of the inlet pipe and a back side of the annular surface of the retainer and rotating the pair of electrodes to form a gap at both ends of the surface contacting region, and melting a zinc plated layer of the inlet pipe to extrude zinc from the zinc plated layer to the gap and filling the gap with the zinc, wherein
a thickness of the zinc plated layer of the inlet pipe is greater than or equal to 11 μm and smaller than or equal to 25 μm.
